(19) United States
(12) Patent Application Publication
(10) Pub. No.: US 2026/0279707 A1
(43) Pub. Date: Sep. 17, 2026

(54) THERMAL PROTECTOR

(71) Applicant: UBUKATA INDUSTRIES CO., LTD., Nagoya-shi, Aichi (JP)

(72) Inventors: Mikitoshi KASUYA, Nagoya-shi, Aichi (JP); Takashi ADAKE, Nagoya-Shi, Aichi (JP)

(21) Appl. No.: 18/877,847

(22) PCT Filed: Jul. 7, 2022
(86) PCT No.: PCT/JP2022/026982

§ 371 Date: Dec. 20, 2024

(51) Int. Cl. H01H 37/52; H01H 37/04

(52) U.S. Cl. CPC H01H 37/52; H01H 37/04

(57) ABSTRACT

A thermal protector includes a base member and a cover member which are formed of a resin, a stationary contact and a movable contact which are provided in a housing space, a fixing member provided with the stationary contact, a movable member provided with the movable contact, and a thermally actuated element. The thermally actuated element performs a deformation operation by receiving heat, and exerts force in a direction, in which the movable contact moves apart from the stationary contact, on the movable member. The base member has a protrusion portion. The cover member has a through hole portion through which the protrusion portion passes. The base member and the cover member are fixed to each other by formation of a thermal caulking portion in a protruding portion. The protruding portion passes through the through hole portion and protrudes to an outside of the cover member.

### CROSS-REFERENCE TO RELATED APPLICATION(S)

This is a National Stage Entry into the United States Patent and Trademark Office from International Patent Application No. PCT/JP2022/026982, filed on Jul. 7, 2022, the entire content of which is incorporated herein by reference.

### FIELD OF THE INVENTION

An embodiment of the present invention relates to a thermal protector.

### BACKGROUND OF THE INVENTION

A thermal protector houses a thermally actuated element and a contact mechanism, which is always closed, in an internal portion of a casing member formed of an insulating resin, the thermally actuated element operates in a case where abnormal heat generation is detected, the contact mechanism is thereby opened, and a current is blocked. The casing member is configured by joining a cover member and a base member to each other, for example. In such a configuration in related art, the cover member and the base member are joined to each other by ultrasonic welding of peripheries of the cover member and the base member.

However, for example, in a case of ultrasonic welding, there is a possibility that the cover member and the base member are subject to abrasion due to high-frequency vibration and abrasion powder is produced in the internal portion of the casing member. Furthermore, when the abrasion powder produced in the internal portion of the casing member enters a portion between contacts, a possibility becomes high that a resistance failure, a conduction failure, or the like is caused, and there is a possibility that as a result lowering of reliability of the thermal protector is incurred.

### SUMMARY OF THE INVENTION

Accordingly, a thermal protector is provided that can achieve an improvement in reliability.

A thermal protector of an embodiment includes: a base member which is configured with a resin having electric insulation and thermal plasticity; a cover member which is configured with a resin having electric insulation, is mounted on the base member, and forms a housing space between the cover member and the base member; a stationary contact and a movable contact which are provided in the housing space; a fixing member which is provided with the stationary contact and is fixed to the base member; a movable member which is provided with the movable contact, is configured to be deformable in the housing space, and exerts force in a direction, in which the movable contact contacts with the stationary contact, on the movable contact; and a thermally actuated element which is housed in the housing space, performs a deformation operation by receiving heat, and exerts force in a direction, in which the movable contact moves apart from the stationary contact, on the movable member. The base member has a protrusion portion which is provided in the base member and protrudes from a surface of the base member. The cover member has a through hole portion which is formed in a position corresponding to the protrusion portion and is formed to pass through the cover member. The base member and the cover member are fixed to each other by formation of a thermal caulking portion, for which thermal caulking is carried out, in a protruding portion, the protruding portion being the protrusion portion which is caused to pass through the through hole portion and protrudes to an outside of the cover member.

### BRIEF DESCRIPTION OF THE DRAWINGS

FIG. 1 is an exploded perspective view illustrating a switch assembly, a first casing, and a second casing, which configure a thermal protector, about an example of a thermal protector according to an embodiment.

FIG. 2 is a perspective view illustrating the switch assembly from a base member side, about the example of the thermal protector according to the embodiment.

FIG. 3 is a perspective view illustrating the switch assembly from a cover member side, about the example of the thermal protector according to the embodiment.

FIG. 4 is a perspective view illustrating the switch assembly from the cover member side and is a diagram illustrating a state before thermal caulking portions are formed in protrusion portions, about the example of the thermal protector according to the embodiment.

FIG. 5 is an exploded perspective view illustrating the switch assembly, about the example of the thermal protector according to the embodiment.

FIG. 6 is a plan view illustrating the switch assembly from the cover member side, about the example of the thermal protector according to the embodiment.

FIG. 7 is a plan view illustrating a state at a time when the switch assembly is being assembled and before the cover member, an abutting member, and clips are mounted on the base member, about the example of the thermal protector according to the embodiment.

FIG. 8 is a cross-sectional view taken along line X8-X8 in FIG. 6, about the example of the thermal protector according to the embodiment.

FIG. 9 is a cross-sectional view taken along line X9-X9 in FIG. 6, about the example of the thermal protector according to the embodiment.

FIG. 10 is a cross-sectional view illustrating a state where a thermally actuated element performs a deformation operation from a state in FIG. 9 and a stationary contact and a movable contact are opened, about the example of the thermal protector according to the embodiment.

FIG. 11 is a cross-sectional view in which a part X11 in FIG. 10 is enlarged and illustrated, about the example of the thermal protector according to the embodiment.

FIG. 12 is a cross-sectional view illustrating a housing form of the switch assembly by sectioning part of the second casing and the first casing, about the example of the thermal protector according to the embodiment.

FIG. 13 is a cross-sectional view in which a part along line X13-X13 in FIG. 12 is enlarged and illustrated, about the example of the thermal protector according to the embodiment.

FIG. 14 is a cross-sectional view in which a part along line X14-X14 in FIG. 12 is enlarged and illustrated, about the example of the thermal protector according to the embodiment.

FIG. 15 is a cross-sectional view in which a part X15 in FIG. 12 is enlarged and illustrated, about the example of the thermal protector according to the embodiment.

### DESCRIPTION OF EMBODIMENT(S) OF THE INVENTION

One embodiment will hereinafter be described with reference to drawings.

A thermal protector of the present invention can be applied to a thermal protector for a three-phase motor, the thermal protector having the three-phase motor as a protection target, for example. The thermal protector of the present invention is mounted on the protection target and has a function of blocking a current to the protection target by detecting heat generation in a case where abnormal heat generation occurs to the protection target. The thermal protector of the present invention can have a three-phase motor as the protection target, for example. In this case, the thermal protector is connected to all winding wires on a neutral point side of a three-phase motor in star connection. Furthermore, the thermal protector blocks all of the winding wires at the neutral point in a case where abnormal heat generation of the three-phase motor is detected. Note that the thermal protector of the present invention can also be applied to a thermal protector for a single-phase motor and can also be applied to a thermal protector which has another apparatus than a motor as the protection target.

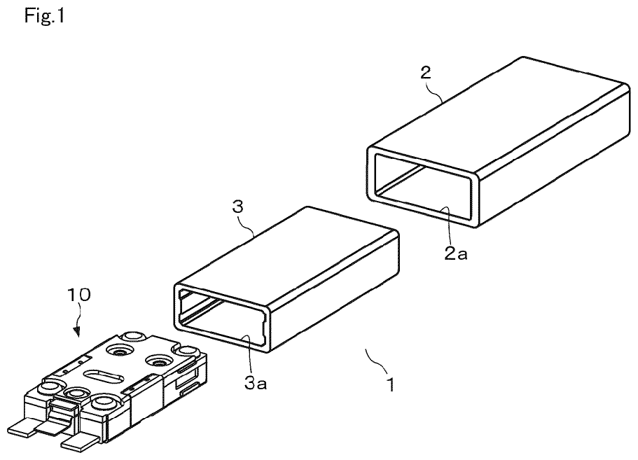

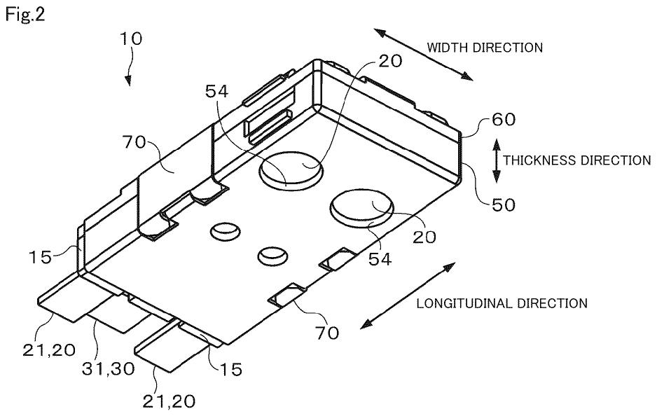

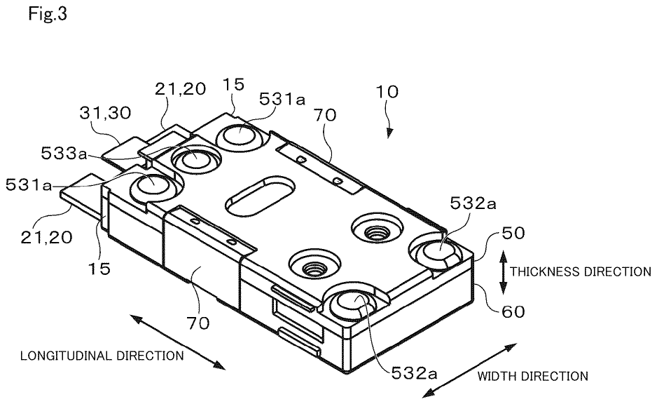

As illustrated in FIG. 1, a thermal protector 1 of the present embodiment includes a second casing 2, a first casing 3, and a switch assembly 10. The switch assembly 10 is a principal configuration of the thermal protector 1 and has a function of blocking a current in a case where abnormal heat generation is detected. As illustrated in FIG. 2 and FIG. 3, the switch assembly 10 is configured, as its whole body, in a rectangular shape, for example, an oblong plate shape. Note that in the following description, a longitudinal direction of the switch assembly 10 might be referred to as a longitudinal direction of the switch assembly 10 and the thermal protector 1, and a direction perpendicular to the longitudinal direction might be referred to as a width direction of the switch assembly 10 and the thermal protector 1.

Furthermore, a direction perpendicular to both of the longitudinal direction and the width direction might be referred to as a height direction or a thickness direction of the switch assembly 10 and the thermal protector 1.

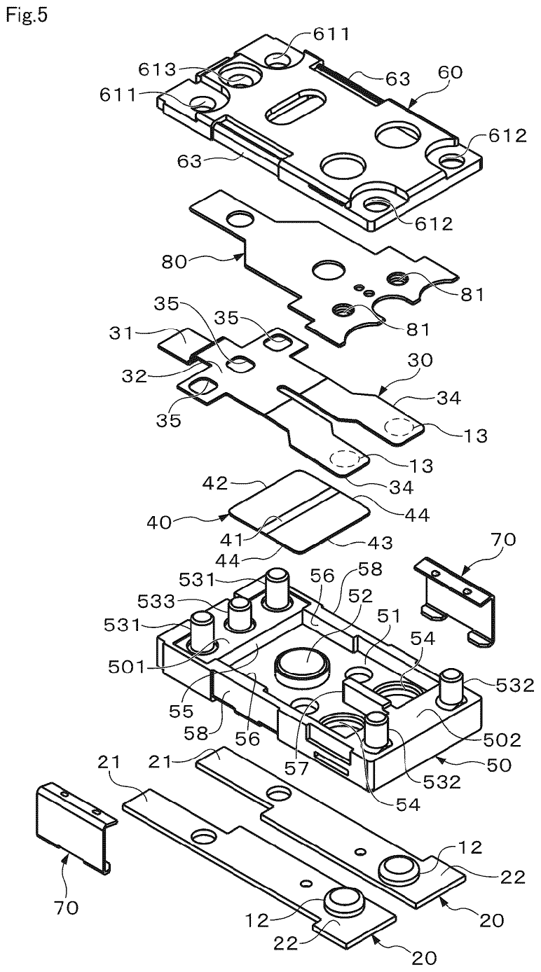

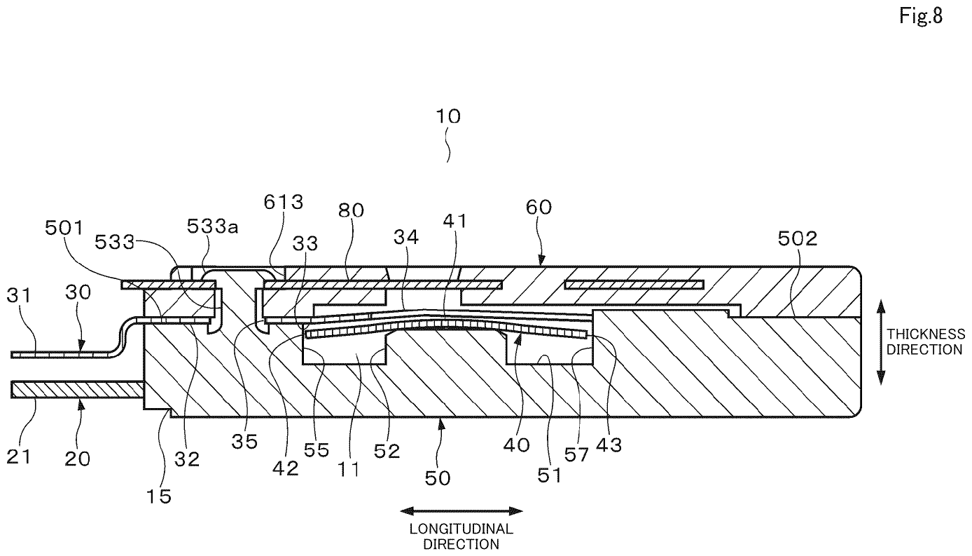

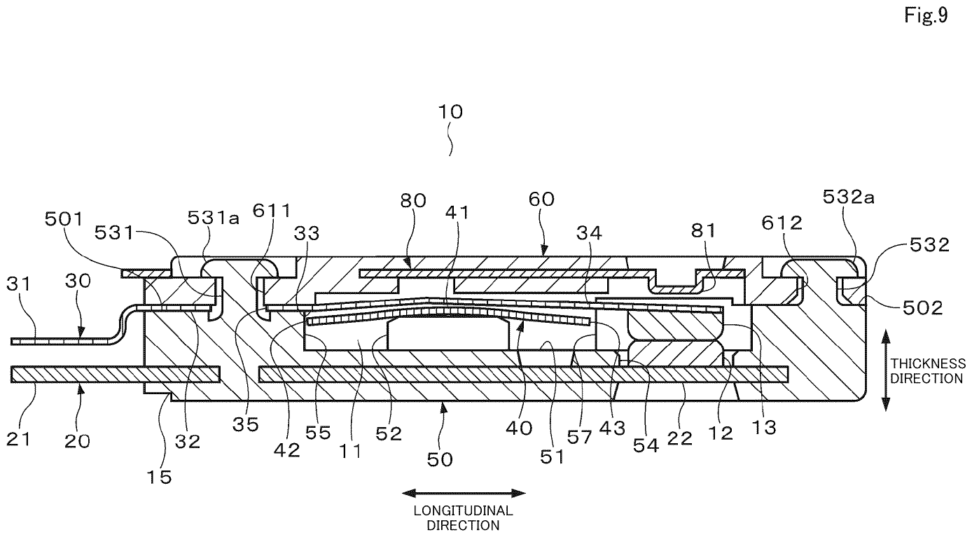

As illustrated in FIG. 5 and so forth, the switch assembly 10 includes stationary contacts 12, movable contacts 13, fixing members 20, a movable member 30, a thermally actuated element 40, a base member 50, a cover member 60, clips 70, and an abutting member 80. The base member 50 and the cover member 60 configure a casing member which serves as an outer shell of the switch assembly 10. The base member 50 and the cover member 60 are combined with each other to configure the outer shell of the switch assembly 10 and form a housing space 11 in an internal portion as illustrated in FIG. 8 and FIG. 9.

As illustrated in FIG. 5 and so forth, the switch assembly 10 has two stationary contacts 12, two movable contacts 13, two fixing members 20, and one movable member 30. The stationary contacts 12, the movable contacts 13, parts of the fixing members 20, part of the movable member 30, and the thermally actuated element 40 are arranged in the housing space 11. The stationary contacts 12, the movable contacts 13, the fixing members 20, and the movable member 30 are always closed and configure a contact mechanism which is opened by an operation of the thermally actuated element 40. The stationary contact 12 and the movable contact 13 can be configured with an alloy containing metal with low electric resistance such as gold, silver, or copper, for example.

The fixing members 20 are fixed to the base member 50. The fixing member 20 is configured with a metal plate which has a long plate shape and electrical conductivity. The fixing member 20 can be configured with a metal plate of steel, copper, stainless steel, or the like, for example. As illustrated in FIG. 9, parts of the fixing members 20 are embedded in the base member 50 by insert molding. As illustrated in FIG. 5, the two fixing members 20 are embedded in the base member 50 while being arranged in parallel in a state where those are spaced apart from each other and are thereby electrically insulated from each other.

As illustrated in FIG. 9 and so forth, one end of each of the fixing members 20 is exposed from the base member 50 to an outside. A portion of the fixing member 20, which is exposed to the outside of the base member 50, might be referred to as a fixing-portion-side connection portion 21. A power line which is linked to an apparatus as the protection target is connected with the fixing-portion-side connection portion 21. In a case of the present embodiment, power lines of two phases among power lines of three phases, which are linked to the apparatus as the protection target, are respectively connected with the fixing-portion-side connection portions 21 of the two fixing members 20. The other end portion 22 of the fixing member 20 is partially exposed in the housing space 11. The stationary contact 12 is provided in the end portion 22 on an opposite side to the fixing-portion-side connection portion 21 and is exposed in the housing space 11.

As illustrated in FIG. 9 and so forth, the movable member 30 is interposed between the base member 50 and the cover member 60 and is supported in a cantilever shape. A part of a portion in the movable member 30 other than a portion interposed between the base member 50 and the cover member 60 is exposed to an outside of the base member 50 and the cover member 60, and the other part is exposed in the housing space 11.

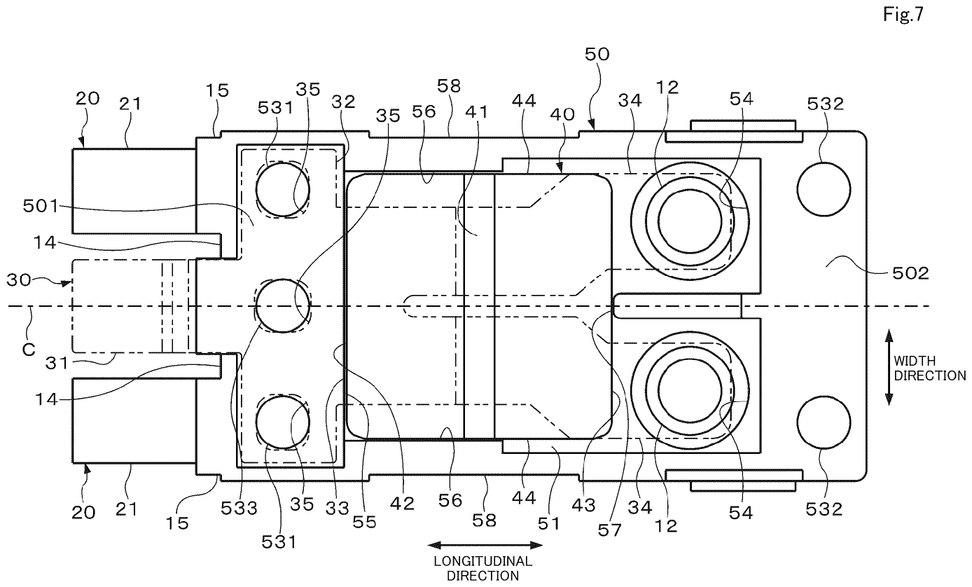

It is preferable that the movable member 30 be configured with an alloy material for a spring, which has comparatively small electrical resistance and high heat resistance. As materials of the movable member 30, for example, a beryllium-copper alloy, a titanium-copper alloy, a Corson copper alloy, and so forth can be used. As illustrated in FIG. 5 and FIG. 7, the movable member 30 as its whole body is configured with a metal plate whose part is bifurcated, for example. A longitudinal direction of the movable member 30 agrees with the longitudinal direction of the switch assembly 10, and a width direction of the movable member 30 agrees with the width direction of the switch assembly 10. The movable member 30 has a movable-portion-side connection portion 31, an interposed portion 32, a fulcrum portion 33, two arm portions 34, and two or more, in this case, three insertion hole portions 35.

As illustrated in FIG. 7, FIG. 8, and FIG. 9, the movable-portion-side connection portion 31 is provided in an end portion, which is not bifurcated, in both end portions of the movable member 30 and is exposed to the outside of the base member 50 and the cover member 60. A power line which is linked to the apparatus as the protection target is connected with the movable-portion-side connection portion 31. In the case of the present embodiment, the power line of one phase among the power lines of three phases, which are linked to the apparatus as the protection target, is connected with the movable-portion-side connection portion 31.

The interposed portion 32 is provided between the movable-portion-side connection portion 31 and the arm portions 34. The interposed portion 32 is a portion which contacts with the base member 50 or the cover member 60 in a state where the movable member 30 is interposed between the base member 50 and the cover member 60, that is, a portion which receives pressing force from the base member 50 and the cover member 60. The interposed portion 32 can be formed into a rectangular shape, for example, an oblong shape which is long in the width direction of the switch assembly 10.

The fulcrum portion 33 is a boundary portion between the interposed portion 32 and the arm portions 34. The arm portions 34 are base points of portions of the movable member 30 which are exposed in the housing space 11, in this case, the bifurcated portions. The arm portion 34 is configured to be deformable at the fulcrum portion 33 as a fulcrum in the housing space 11, that is, to be swingable in the thickness direction.

The movable contact 13 is provided in a position which is around a distal end of the bifurcated portion of the movable member 30, that is, around a distal end of the arm portion 34 and which is opposed to the corresponding stationary contact 12. In a state where external force is not exerted on the movable member 30, in other words, in a case where the movable member 30 is not assembled as the switch assembly 10, the movable member 30 is formed in a shape which is curved to bulge toward the cover member 60 side. Furthermore, when being assembled into the switch assembly 10, the movable member 30 is fixed between the base member 50 and the cover member 60 in a state where the movable contacts 13 are brought into contact with the stationary contacts 12 and the arm portions 34 are elastically deformed at the fulcrum portion 33 as the fulcrum. By elastic force, in other words, restoring force of the movable member 30, the movable member 30 exerts force on the movable contacts 13 in a direction to press the movable contacts 13 onto the stationary contacts 12.

In a case where the arm portion 34 does not receive external force other than resistance force from the stationary contact 12, the arm portion 34 presses the movable contact 13 onto the stationary contact 12 by the elastic force of the movable member 30. In this case, the thermal protector 1 becomes a closed state, in other words, a state where the fixing-portion-side connection portions 21 of the fixing members 20 are electrically continuous with the connection portion 31 of the movable member 30. On the other hand, when the arm portions 34 receive external force which is force in a direction in which the movable contacts 13 move apart from the stationary contacts 12, in other words, which is force in an upward direction on the page of FIG. 9 and is larger than the elastic force of the movable member 30, the arm portions 34 deform in a direction in which the movable contacts 13 move apart from the stationary contacts 12, and as a result, the movable contacts 13 move apart from the stationary contacts 12. In this case, the thermal protector 1 becomes an open state, in other words, a state where the fixing-portion-side connection portions 21 of the fixing members 20 are electrically blocked from the connection portion 31 of the movable member 30.

As illustrated in FIG. 5 and FIG. 8, the insertion hole portion 35 is formed to pass through the interposed portion 32 in the thickness direction. The insertion hole portion 35 is a circular, quadrangular, or elliptical hole, for example. In the case of the present embodiment, the movable member 30 has three insertion hole portions 35. The three insertion hole portions 35 are, for example, linearly arranged in a longitudinal direction of the interposed portion 32, in other words, in the width direction of the movable member 30. As illustrated in FIG. 7, one of the three insertion hole portions 35 is provided on a center line C in the width direction of the movable member 30.

The thermally actuated element 40 is housed in the housing space 11 and is provided between the fixing members 20 and the movable member 30 when viewed in the thickness direction of the switch assembly 10, as illustrated in FIG. 8 and so forth. The thermally actuated element 40 is configured in a rectangular plate shape with bimetal. The thermally actuated element 40 is arranged in the housing space 11 without being fixed. The thermally actuated element 40 performs a deformation operation by receiving heat and thereby exerts force, in the direction in which the movable contacts 13 move apart from the stationary contacts 12, on the movable member 30.

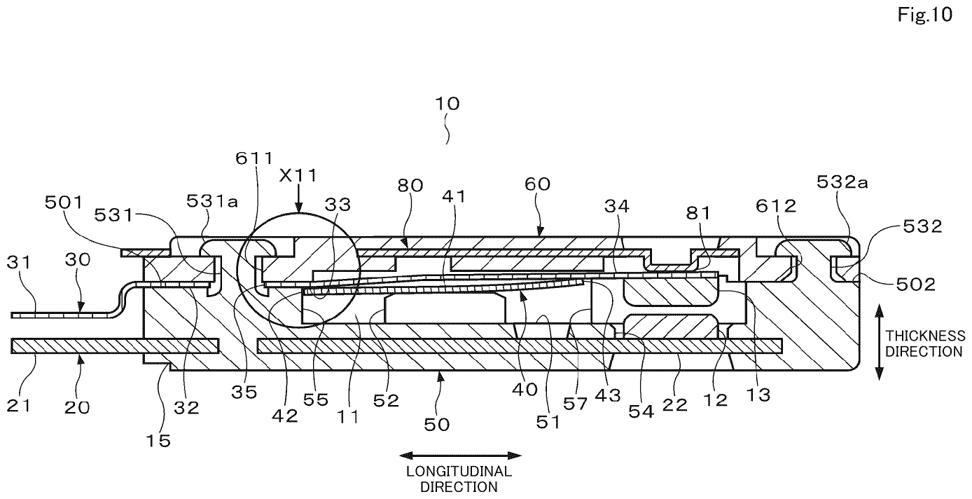

As illustrated in FIG. 9, in a state where the deformation operation is not performed, the thermally actuated element 40 has a shape which has a portion around a center of the thermally actuated element 40 as an apex 41 and is curved like a ridge from the apex 41 to both end sides in the longitudinal direction of the switch assembly 10 or a dish shape which has the apex 41 and is spherically curved. The thermally actuated element 40 performs the deformation operation when receiving predetermined heat, and its curved direction is inverted as illustrated in FIG. 10. Then, a side portion 42 on one end side of the thermally actuated element 40 in the longitudinal direction of the switch assembly 10 contacts with a portion around the fulcrum portion 33 of the movable member 30. Further, a side portion 43 on the other end side of the thermally actuated element 40 in the longitudinal direction of the switch assembly 10 contacts with the arm portions 34. A projection portion may be provided in a section, which the side portion 43 abuts, of the arm portion 34.

Note that in the following description, among side portions 42, 43, and 44 on a periphery of the thermally actuated element 40, the side portion 42 which contacts with the portion around the fulcrum portion 33 in a case where the deformation operation is performed might be referred to as a rear side portion 42. Further, among the side portions 42, 43, and 44 on the periphery of the thermally actuated element 40, the side portion 43 which contacts with the arm portions 34 in a case where the deformation operation is performed might be referred to as a front side portion 43. Furthermore, among the side portions 42, 43, and 44 on the periphery of the thermally actuated element 40, the side portion interposed between the rear side portion 42 and the front side portion 43 might be referred to as a lateral side portion 44.

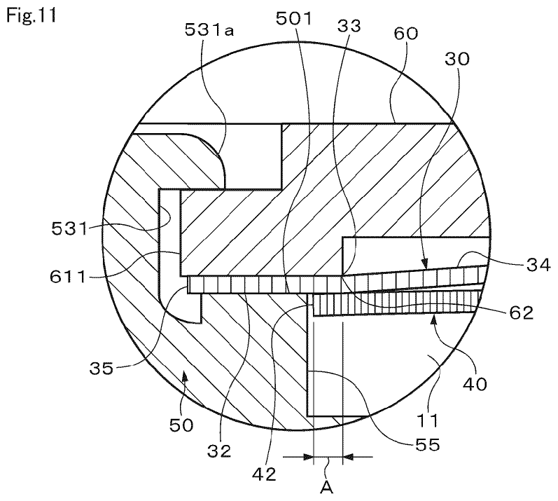

Here, as illustrated in FIG. 11, because the portion around the fulcrum portion 33 is interposed between the base member 50 and the cover member 60, the above portion is less likely to deform even in a case where it receives force from the thermally actuated element 40. Thus, when performing the deformation operation, the thermally actuated element 40 swings at the side portion 42, which contacts with the portion around the fulcrum portion 33, as the fulcrum. The side portion 43, which contacts with the arm portions 34, in the thermally actuated element 40 then lifts the arm portions 34 to the cover member 60 side. Accordingly, the movable contacts 13 are moved apart from the stationary contacts 12, and the thermal protector 1 is switched to the open state, in other words, a state where power supply to the apparatus as the protection target is blocked.

As illustrated in FIG. 11, in a portion where the movable member 30 is interposed between the cover member 60 and the base member 50, that is, where the cover member 60 contacts with the interposed portion 32, the cover member 60 extends outside to a distal end side of the movable member 30, that is, the arm portion 34 side relatively to the base member 50. In other words, the rear side portion 42 of the thermally actuated element 40 overlaps with a portion, which contacts with the movable member 30, in the cover member 60 in a planar view in a region A portion in FIG. 11.

In this configuration, in a case where the thermally actuated element 40 performs the deformation operation and the rear side portion 42 of the thermally actuated element 40 contacts with the movable member 30, the cover member 60 can receive force, which is applied from the rear side portion 42 to the movable member 30, by the region A portion in the cover member 60. Thus, even in a case where a boundary portion 62 in the cover member 60 between a portion which contacts with the movable member 30 and a portion which does not contact with the movable member 30 has a corner shape, large shearing force can be inhibited from being exerted on a portion, which contacts with the boundary portion 62, in the movable member 30, and as a result, deformation or fracture of the movable member 30 can be inhibited.

The base member 50 is configured with a resin having electric insulation and thermal plasticity, for example. It is preferable that the base member 50 be configured with a member which has heat resistance and electric insulation and has proper adhesiveness for an epoxy-based adhesive, for example. The base member 50 can be configured with polyphenylene sulfide (PPS) in which approximately 30% to 40% of glass fiber is mixed, for example. The base member 50 is configured, as its whole body, in an oblong plate shape, for example.

As illustrated in FIG. 5 and FIG. 7 to FIG. 9, the base member 50 is configured to have a recess portion 51, a support portion 52, a plurality of protrusion portions 531, 532, and 533, contact hole portions 54, a rear wall portion 55, side wall portions 56, and an intermediate wall portion 57. The recess portion 51, the support portion 52, the plurality of protrusion portions 531, 532, and 533, the contact hole portions 54, the rear wall portion 55, the side wall portions 56, and the intermediate wall portion 57 are integrally formed by resin molding. The protrusion portions 531 and 533 are provided on one side in a longitudinal direction of the base member 50 in a planar view, and the protrusion portion 532 is provided on the other side in the longitudinal direction of the base member 50.

The recess portion 51 is a portion which is formed by recessing, as the recess portion 51, a surface in the base member 50 on a side opposed to the cover member 60. The recess portion 51 is a portion which forms the housing space 11 when the cover member 60 is mounted on the base member 50. The support portion 52 has a function of supporting the thermally actuated element 40. The support portion 52 is provided around a center of the base member 50 in its width direction in the recess portion 51 and protrudes in a columnar shape from a bottom portion of the recess portion 51. In this case, the thermally actuated element 40 is only supported by the support portion 52 and does not receive pressing force or urging force from other members.

The base member 50 has five protrusion portions 531, 532, and 533. Each of the protrusion portions 531, 532, and 533 is formed to protrude from a surface 501 or 502 of the base member 50. Four protrusion portions 531, 531, 532, and 532 are respectively provided around corner portions of the base member 50. One remaining protrusion portion 533 is provided on a straight line connecting two protrusion portions 531 and 531 aligned in the width direction and in an intermediate portion of the two protrusion portions 531 and 531. In the case of the present embodiment, height dimensions of the protrusion portions 531 and 532 provided around the corner portions are almost equivalent to a thickness dimension of the base member 50 without the protrusion portions 531 and 532.

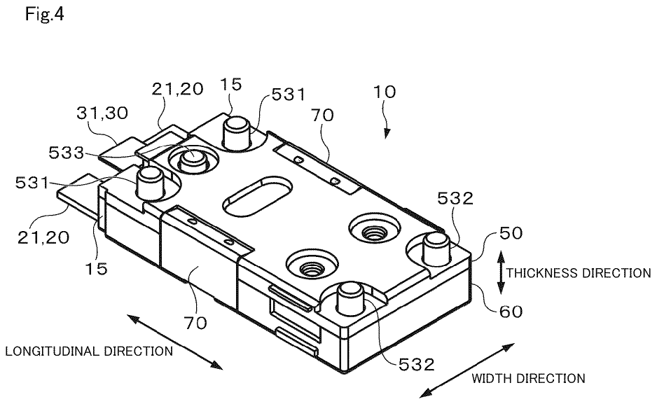

In a state before the base member 50 and the cover member 60 are joined together, as illustrated in FIG. 4 and FIG. 5, each of the protrusion portions 531, 532, and 533 has a columnar rod shape. In a state after the base member 50 and the cover member 60 are joined together, as illustrated in FIG. 3, FIG. 8, and FIG. 9, thermal caulking portions 531a, 532a, and 533a are respectively formed in distal end portions of the protrusion portions 531, 532, and 533. The thermal caulking portions 531a, 532a, and 533a are portions which are formed by carrying out a process in which portions, which are exposed to the outside of the cover member 60, in the protrusion portions 531, 532, and 533 are crushed in a state where those portions are heated and softened, so-called thermal caulking. Outer diameters of the thermal caulking portions 531a, 532a, and 533a are larger than inner diameters of through hole portions 611, 612, and 613 of the cover member 60.

Each of the base member 50 and the cover member 60 is configured, as its whole body, in a rectangular shape in a planar view, for example, an oblong shape. The thermal caulking portions 531a and 532a are provided at least in corner portions of the base member 50 and the cover member 60. In the case of the present embodiment, the thermal caulking portion 533a is further provided between the two thermal caulking portions 531a.

As illustrated in FIG. 5, FIG. 7, and FIG. 9, two contact hole portions 54 are provided in the recess portion 51. As illustrated in FIG. 9 and so forth, the contact hole portion 54 is formed to pass through the bottom portion of the recess portion 51 in a circular shape. The two contact hole portions 54 are arranged to be aligned in the width direction of the base member 50 in the recess portion 51. In the longitudinal direction of the base member 50, the two contact hole portions 54 are provided close to an opposite side to the three protrusion portions 531, 532, and 533 aligned in the width direction of the base member 50. The stationary contact 12 provided on the fixing member 20 is exposed from the contact hole portion 54 in the housing space 11.

As illustrated in FIG. 5 and FIG. 7, the rear wall portion 55, the side wall portions 56, and the intermediate wall portion 57 have a function of defining a position of the thermally actuated element 40 to be arranged in the recess portion 51. The rear wall portion 55 and the side wall portions 56 configure part of wall portions around the recess portion 51. The rear wall portion 55 is a wall portion on the protrusion portions 531 and 533 side among the wall portions around the recess portion 51.

The rear wall portion 55 has a function of regulating movement of the thermally actuated element 40 in the longitudinal direction of the base member 50 and to the protrusion portions 531 and 533 side, that is, movement to the left side on the page of FIG. 7. The rear wall portion 55 contacts with one of the side portions, which extend in the width direction of the base member 50, in an outer periphery of the thermally actuated element 40, that is, the side portion 42 on one side in the longitudinal direction of the base member 50. The rear wall portion 55 is provided throughout a whole range of the side portion 42 of the thermally actuated element 40.

The side wall portion 56 has a function of regulating movement of the thermally actuated element 40 in the width direction of the base member 50. Two side wall portions 56 are provided on both sides of the recess portion 51 in the width direction. The side wall portions 56 contact with part of the side portions 44, which extend in the longitudinal direction of the base member 50, in the outer periphery of the thermally actuated element 40, that is, part of the side portions 44 positioned on both sides in the width direction. The two side wall portions 56 are provided throughout part of the side portions 44 of the thermally actuated element 40 in the width direction. In the longitudinal direction of the base member 50, the two side wall portions 56 are provided close to the rear wall portion 55 side.

The intermediate wall portion 57 has a function of regulating movement of the thermally actuated element 40 in the longitudinal direction of the base member 50 and to the protrusion portions 532 side, that is, movement to the right side on the page of FIG. 7. The intermediate wall portion 57 is provided to rise from the bottom portion of the recess portion 51. The intermediate wall portion 57 is provided in a central portion in the width direction of the base member 50 in the recess portion 51. The intermediate wall portion 57 is provided between the two contact hole portions 54 and extends in the longitudinal direction of the base member 50. The intermediate wall portion 57 contacts with one remaining side portion 43 in the side portions, which extend in the width direction of the base member 50, in the outer periphery of the thermally actuated element 40. Further, the intermediate wall portion 57 has a function of securing an insulation distance between the stationary contacts 12 and 12 which are arranged in the two contact hole portions 54 and are in different phase.

When being arranged on an inside of the recess portion 51, the thermally actuated element 40 contacts with the rear wall portion 55 and the intermediate wall portion 57, and the position of the thermally actuated element 40 in the longitudinal direction with respect to the base member 50 is thereby defined. The thermally actuated element 40 contacts with the side wall portions 56, and the position of the thermally actuated element 40 in the width direction with respect to the base member 50 is thereby defined. In a case where the thermally actuated element 40 does not perform the deformation operation, an outer periphery portion of the thermally actuated element 40 does not contact with any other portion than the rear wall portion 55, the side wall portions 56, and the intermediate wall portion 57.

The cover member 60 is configured with a resin having electric insulation, is mounted on the base member 50, and forms the housing space 11 between the cover member 60 and the base member 50. The cover member 60 seals the recess portion 51 of the base member 50 and thereby forms the inside of the recess portion 51 as the housing space 11. Similarly to the base member 50, the cover member 60 can be configured with polyphenylene sulfide (PPS) in which approximately 30% to 40% of glass fiber is mixed, for example.

As illustrated in FIG. 5 and so forth, the cover member 60 has a plurality of, for example, five through hole portions 611, 612, and 613. The through hole portions 611, 612, and 613 are formed in positions corresponding to the protrusion portions 531, 532, and 533. Each of the through hole portions 611, 612, and 613 is formed to pass through the cover member 60 in a circular shape, for example. The inner diameters of the through hole portions 611, 612, and 613 are slightly larger than outer shapes of the corresponding protrusion portions 531, 532, and 533.

The base member 50 and the cover member 60 are joined to each other without using a member such as a fastening member such as a screw or an adhesive, for example, in other words, without using any other member than the base member 50 and the cover member 60. The base member 50 and the cover member 60 are joined to each other without using ultrasonic welding. When the switch assembly 10 is assembled, the base member 50 and the cover member 60 are joined to each other in the following manner.

First, the thermally actuated element 40 is arranged on the support portion 52 in the recess portion 51 of the base member 50. Next, in a state where the three protrusion portions 531 and 533 are inserted in the insertion hole portions 35 of the movable member 30, the movable member 30 is arranged in the base member 50. Next, the corresponding protrusion portions 531, 532, and 533 are inserted into the through hole portions 611, 612, and 612 of the cover member 60, and the cover member 60 and the base member 50 are combined together.

In this case, as illustrated in FIG. 4, the distal end portions of the protrusion portions 531, 532, and 533 protrude from the through hole portions 611, 612, and 612 to the outside of the cover member 60. Furthermore, thermal caulking is carried out for portions, which protrude to the outside of the cover member 60, in the protrusion portions 531, 532, and 533. By this thermal caulking, the distal end portions of the protrusion portions 531, 532, and 533 are crushed in a softened state, and the thermal caulking portions 531a, 532a, and 533a are thereby formed. The thermal caulking portions 531a, 532a, and 533a are locked in the through hole portions 611, 612, and 613, and the base member 50 and the cover member 60 are thereby fixed to each other. This thermal caulking is different from ultrasonic welding or the like and does not use high-frequency vibration. Thus, vibration in ultrasonic welding as a cause of production of abrasion powder is not applied to the base member 50 or the cover member 60, and the abrasion powder can be inhibited from being produced in the housing space 11.

The clip 70 is mounted on long-side portions of the base member 50 and the cover member 60. The clip 70 interposes and retains the base member 50 and the cover member 60 from the outside of the base member 50 and the cover member 60. The clip 70 is formed by folding a metal plate such as a spring plate, for example. The clip 70 exerts force in a direction in which the base member 50 and the cover member 60 move close to each other and inhibits the base member 50 and the cover member 60 from moving apart from each other.

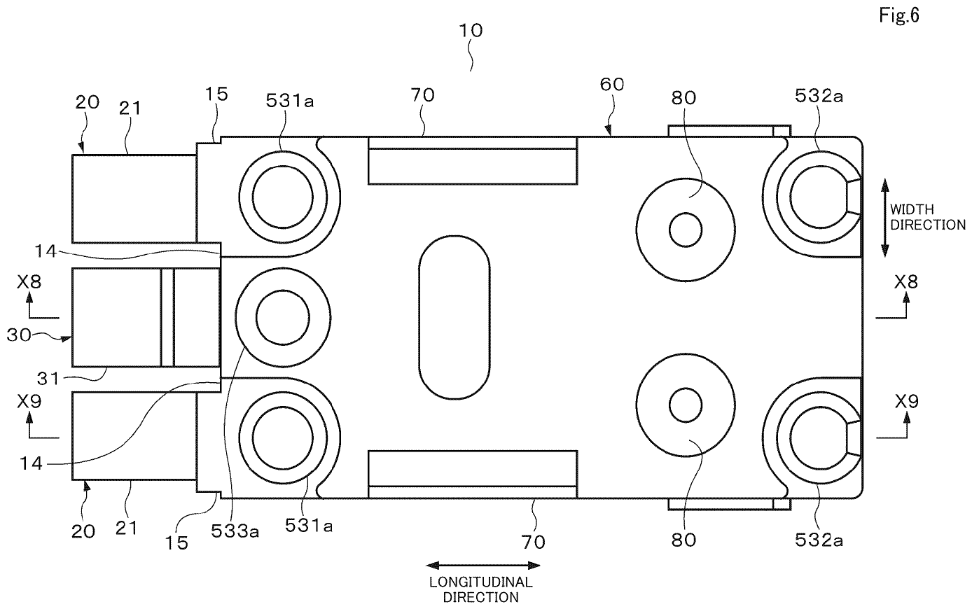

As illustrated in FIG. 6, when viewed in a planar view of the switch assembly 10, the clips 70 are provided around central portions in the longitudinal direction of the base member 50 and the cover member 60. In the longitudinal direction of the switch assembly 10, the clips 70 are positioned between the protrusion portions 531 and 533 and the protrusion portions 532.

As illustrated in FIG. 5, the base member 50 has base-portion-side receiving portions 58. The base-portion-side receiving portion 58 is a portion which is formed by recessing a side surface portion of the base member 50 by an approximate thickness of the clip 70. The cover member 60 has cover-portion-side receiving portions 63. The cover-portion-side receiving portion 63 is a portion which is formed by recessing a side surface portion of the cover member 60 by an approximate thickness of the clip 70. In a case where the base member 50 and the cover member 60 are combined together, the base-portion-side receiving portion 58 and the cover-portion-side receiving portion 63 come to almost the same surface. The clip 70 is then fitted in the base-portion-side receiving portion 58 and the cover-portion-side receiving portion 63.

As illustrated in FIG. 8 to FIG. 10, the abutting member 80 is embedded in the cover member 60 by insert molding. The abutting member 80 is provided on an opposite side to the thermally actuated element 40 with respect to the movable member 30. The abutting member 80 has a function of dissipating heat generated in the movable contacts 13 and the movable member 30 when the switch assembly 10 is opened. The abutting member 80 can be configured with a metal plate having high thermal conductivity such as a stainless steel plate or a copper plate, for example.

The abutting member 80 has contact portions 81. The contact portions 81 are provided in positions overlapping with the movable contacts 13 in a planar view and are exposed in the housing space 11. The movable member 30 contacts with the contact portions 81 of the abutting member 80 in a case where the movable member 30 deforms in the direction in which the movable contacts 13 move apart from the stationary contacts 12. In this case, heat generated in the movable contacts 13 and the movable member 30 is dissipated to the cover member 60 via the abutting member 80.

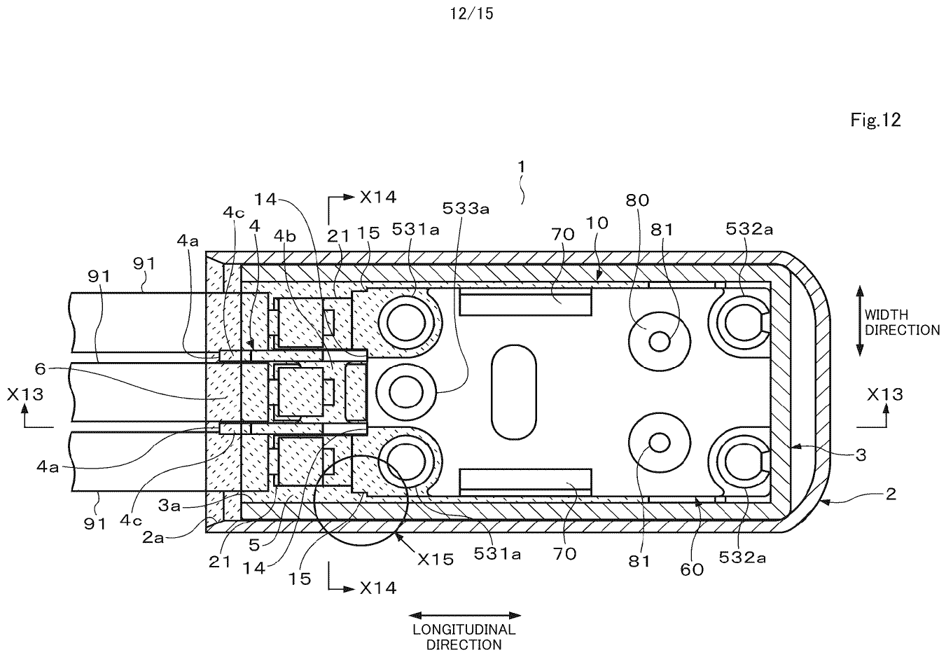

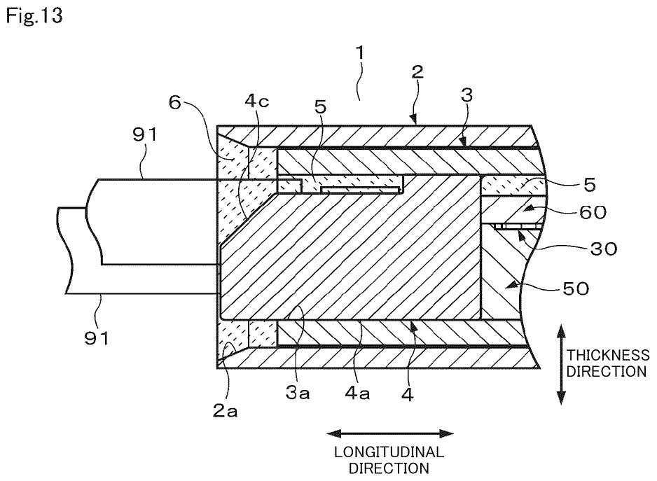

As illustrated in FIG. 12 and FIG. 13, power lines 91 are electrically and physically connected with the connection portions 21 and 31 of the switch assembly 10 by welding or the like. As illustrated in FIG. 1, FIG. 12, and FIG. 13, the thermal protector 1 is configured such that the first casing 3 is inserted in the second casing 2 and further the switch assembly 10 is inserted in the first casing 3. The second casing 2 can be configured with metal such as a steel plate, stainless steel, or copper, for example, and is configured into a box shape which has a second opening portion 2a in one surface of a cube. In order to improve mechanical strength and thermal conductivity, for example, plating finish may be carried out for the second casing 2. Further, the second casing 2 can be configured with a resin member having high strength such as so-called engineering plastic, for example.

The first casing 3 is configured into a box shape which has a first opening portion 3a in one surface of a cube. The first casing 3 is configured with a resin having electric insulation and houses the switch assembly 10 in an internal portion. The first casing 3 can be configured with polyethylene terephthalate (PBT) in which approximately 30% to 40% of glass fiber is mixed, for example.

The thermal protector 1 can be assembled in the following manner, for example. First, the switch assembly 10 in which the power lines 91 are connected with the connection portions 21 and 31 is inserted in the first casing 3. Next, the first casing 3 which houses the switch assembly 10 is inserted in the second casing 2. Accordingly, the thermal protector 1 is assembled.

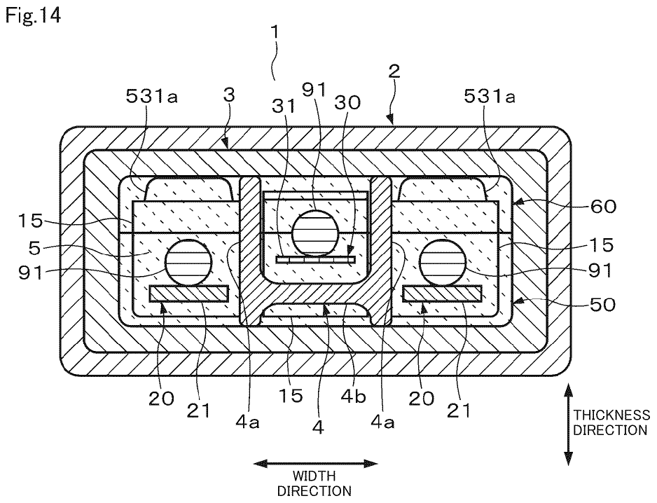

As illustrated in FIG. 12 to FIG. 15, the thermal protector 1 further includes an insulation member 4, a first filling material 5, and a second filling material 6. The insulation member 4 is configured with a resin material having electric insulation. The insulation member 4 is inserted between the adjacent connection portions 21 and 31, regulates movement of the power lines 91 connected with the connection portions 21 and 31, and secures insulation among the power lines 91.

The insulation member 4 can be configured with the same material as that of the first casing 3, for example, polyethylene terephthalate (PBT) in which approximately 30% to 40% of glass fiber is mixed, for example. The insulation member 4 integrally has two partition wall portions 4a and a connection portion 4b. The two partition wall portions 4a are arranged in parallel to be opposed to each other in plate-shaped portions extending in the longitudinal direction of the switch assembly 10. The partition wall portion 4a is arranged between the fixing-portion-side connection portion 21 and the movable-portion-side connection portion 31.

The connection portion 4b connects the two partition wall portions 4a together. The connection portion 4b is formed into a plate shape which has a surface at a right angle with respect to the partition wall portions 4a. The connection portion 4b is arranged close to one side in the thickness direction of the switch assembly 10, in this case, close to the base member 50 side.

As illustrated in FIG. 6, the switch assembly 10 further has two inserted portions 14. The inserted portion 14 is provided to correspond to the partition wall portion 4a and is formed by recessing the base member 50 and the cover member 60. When the insulation member 4 is mounted on the switch assembly 10, a distal end portion of the partition wall portion 4a enters the inserted portion 14. Accordingly, a mounting position of the insulation member 4 with respect to the switch assembly 10 is defined.

An end portion, which is positioned on an outer side, in end portions in the insulation member 4 in the longitudinal direction is not covered by the first filling material 5 and is exposed from the first filling material 5 and the first casing 3. The end portion, which is positioned on the outer side, in the end portions in the insulation member 4 in the longitudinal direction is formed to be asymmetric when viewed in the thickness direction of the switch assembly 10. The insulation member 4 has an asymmetric portion 4c. The asymmetric portion 4c can be configured with a notch portion in which a corner of the partition wall portion 4a on the outer side is cut off, for example. When handling the switch assembly 10, a worker, an assembly device, or the like checks positions of the asymmetric portions 4c of the insulation member 4 and can thereby identify face and back of the switch assembly 10.

As hatched by broken lines in FIG. 12 and FIG. 13, portions between the switch assembly 10 and the first casing 3 are filled with the first filling material 5. The first filling material 5 is a member having electric insulation, and for example, a thermosetting resin such as an epoxy adhesive can be used. After the switch assembly 10 and the insulation member 4 are inserted in the first casing 3, an inside of the first casing 3 is filled with the first filling material 5 through the first opening portion 3a of the first casing 3.

In FIG. 12 and FIG. 13, the second filling material 6 is hatched by broken lines in a direction orthogonal to the hatching of the first filling material 5. Portions in the second casing 2, which contact with the first filling material 5 around the second opening portion 2a of the second casing 2, are filled with the second filling material 6. The second filling material 6 is a member having electric insulation, and for example, similarly to the first filling material 5, a thermosetting resin such as an epoxy adhesive can be used. After the first casing 3 which houses the switch assembly 10 and the insulation member 4 is inserted in the second casing 2, an inside of the second casing 2 is filled with the second filling material 6 through the second opening portion 2a of the second casing 2. The inside of the second casing 2 is filled with the second filling material 6 through the second opening portion 2a, and the second filling material 6 seals the second opening portion 2a and fixes the first casing 3 in the second casing 2. Note that for example, a configuration is possible in which gaps between the first casing 3 and the second casing 2 are enlarged and the gaps are filled with the second filling material 6.

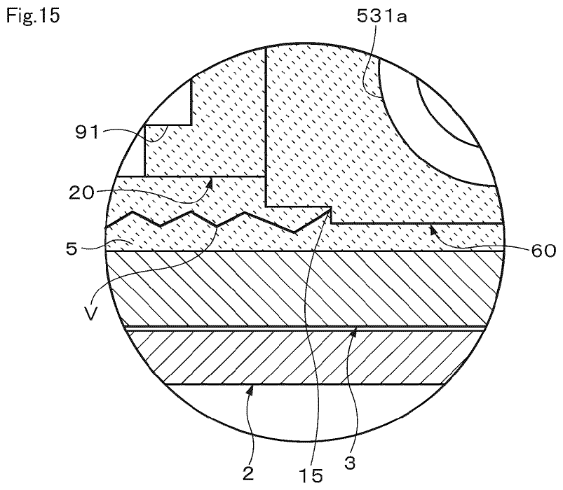

Further, as illustrated in FIG. 2 to FIG. 4, FIG. 12, and FIG. 15, the switch assembly 10 has step portions 15. The step portion 15 is a step-shaped portion which is provided in a periphery of the switch assembly 10 on the first opening portion 3a side of the first casing 3, and the step portion 15 with which the first filling material 5 contacts is provided through the base member 50 and the cover member 60. As illustrated in FIG. 15, the step portion 15 has a function of inhibiting progresses of a crack V of the first filling material 5, which occurs from the first opening portion 3a side, and of peeling of an adhesion surface. For example, as illustrated in FIG. 15, the crack V of the first filling material 5 which occurs from the first opening portion 3a side reaches the step portion 15, and a progress of the crack V is thereby stopped.

The thermal protector 1 of the present embodiment includes the base member 50, the cover member 60, the stationary contacts 12, the movable contacts 13, the fixing members 20, the movable member 30, and the thermally actuated element 40. The base member 50 is configured with a resin having electric insulation and thermal plasticity. The cover member 60 is configured with a resin having electric insulation, is mounted on the base member 50, and forms the housing space 11 between the cover member 60 and the base member 50. The stationary contacts 12 and the movable contacts 13 are provided in the housing space 11. The fixing members 20 are provided with the stationary contacts 12 and are fixed to the base member 50. The movable member 30 is provided with the movable contacts, is configured to be deformable in the housing space 11, and exerts force in a direction, in which the movable contacts 13 contact with the stationary contacts 12, on the movable contacts 13. The thermally actuated element 40 is housed in the housing space 11, performs the deformation operation by receiving heat, and thereby exerts the force in the direction, in which the movable contacts 13 move apart from the stationary contacts 12, on the movable member 30.

The base member 50 has the protrusion portions 531, 532, and 533. Each of the protrusion portions 531, 532, and 533 is provided in the base member 50 and protrudes from the surface 501 or 502 of the base member 50. The cover member 60 has the through hole portions 611, 612, and 613. The through hole portions 611, 612, and 613 are formed in the positions corresponding to the protrusion portions 531, 532, and 533 and are formed to pass through the cover member 60. The protrusion portions 531, 532, and 533 are caused to pass through the through hole portions 611, 612, and 613 and protrude to the outside of the cover member 60, the thermal caulking portions 531a, 532a, and 533a for which thermal caulking is carried out are formed in the above protruding portions, and the base member 50 and the cover member 60 are thereby fixed to each other.

Consequently, the base member 50 and the cover member 60 can be joined to each other without using ultrasonic welding. Thus, vibration in ultrasonic welding as a cause of production of the abrasion powder is not applied to the base member 50 or the cover member 60, and the abrasion powder can thereby be inhibited from being produced in the housing space 11. Furthermore, because the abrasion powder produced in the housing space 11 is inhibited from entering the portion between the contacts 12 and 13, an occurrence of a resistance failure, a conduction failure, or the like due to the abrasion powder can be reduced, and as a result, an improvement in reliability of the thermal protector 1 can be achieved.

Meanwhile, the thermal protector 1 further includes the clips 70. The clips 70 are mounted on the long-side portions of the base member 50 and the cover member 60 and interpose and retain the base member 50 and the cover member 60 from the outside of the base member 50 and the cover member 60. Consequently, even in a case where the base member 50 and the cover member 60 are joined together by using partial thermal caulking, the base member 50 and the cover member 60 can more certainly be attached tightly. Accordingly, a situation can be inhibited where a gap is produced between the base member 50 and the cover member 60 and a foreign body, the first filling material 5, or the like enters an inside of the housing space 11 through the gap. As a result, a further improvement in reliability of the thermal protector 1 can be achieved.

The movable member 30 has two or more insertion hole portions 35. In the case of the present embodiment, the movable member 30 has three insertion hole portions 35. The insertion hole portion 35 is positioned in the interposed portion 32 as the portion to be interposed between the base member 50 and the cover member 60 and is formed to pass through the movable member 30 in the thickness direction. The protrusion portions 531, 532, and 533 are inserted in the corresponding insertion hole portions 35.

Consequently, without causing the movable member 30 to adhere to the base member 50 or the cover member 60, the movable member 30 can be assembled in the switch assembly 10. That is, in this configuration, in the same step as a step of joining the base member 50 and the cover member 60 together, the movable member 30 can be fixed between the base member 50 and the cover member 60. Thus, assembly steps of the switch assembly 10 can be simplified.

The movable member 30 is interposed between the base member 50 and the cover member 60 and is supported in the cantilever shape. As illustrated in FIG. 11, a portion, which contacts with the interposed portion 32 of the movable member 30, in the cover member 60 extends outside to the distal end side of the movable member 30, that is, the arm portion 34 side by the region A portion relatively to the base member 50.

Consequently, even in a case where the boundary portion 62 in the cover member 60 between the portion which contacts with the movable member 30 and the portion which does not contact with the movable member 30 has a corner shape, large shearing force can be inhibited from being exerted on the portion, which contacts with the boundary portion 62, in the movable member 30 from the rear side portion 42 of the thermally actuated element 40, and as a result, deformation or fracture of the movable member 30 can be inhibited.

The thermal protector 1 further includes the abutting member 80. The abutting member 80 is formed of metal and is provided in the cover member 60 by insert molding. The movable member 30 contacts with the abutting member 80 in a case where the movable member 30 deforms in the direction in which the movable contacts 13 move apart from the stationary contacts 12. Heat of the movable contacts 13 in a case where the stationary contacts 12 and the movable contacts 13 are opened can be released to the cover member 60 via the abutting member 80. Thus, trouble can be inhibited such as a situation where excessive heat is applied to the movable member 30 and a spring constant of the movable member 30 thereby changes.

The thermally actuated element 40 is arranged in the housing space 11 without being fixed. Consequently, because a step of fixing the thermally actuated element 40 to the base member 50 or the cover member 60 can be skipped, assembly steps of the switch assembly 10 can be simplified.

The thermal protector 1 further includes the switch assembly 10, the first casing 3, and the first filling material 5. The switch assembly 10 is configured by assembling the base member 50, the cover member 60, the stationary contacts 12, the movable contacts 13, the fixing members 20, the movable member 30, and the thermally actuated element 40. The first casing 3 is configured to be capable of housing the switch assembly 10 and has the first opening portion 3a through which the switch assembly 10 is inserted. The portions in the first casing 3 and around the switch assembly 10 are filled with the first filling material 5 through the first opening portion 3a of the first casing 3, and the switch assembly 10 has the step portions 15 with which the first filling material 5 contacts.

Consequently, as illustrated in FIG. 15, for example, the crack V of the first filling material 5 which occurs from the first opening portion 3a side reaches the step portion 15, and a progress of the crack V is thereby stopped. Thus, the step portion 15 can inhibit progresses of the crack V of the first filling material 5, which occurs from the first opening portion 3a side, and of peeling of the adhesion surface. Accordingly, lowering of insulation performance due to enlargement of the crack V can be inhibited, and as a result, an improvement in reliability of the thermal protector 1 can be achieved.

The thermal protector 1 further includes the second casing 2 and the second filling material 6. The second casing 2 is configured to be capable of housing the first casing 3 which houses the switch assembly 10 and has the second opening portion 2a through which the first casing 3 is inserted. The inside of the second casing 2 is filled with the second filling material 6 through the second opening portion 2a, and the second filling material 6 seals the second opening portion 2a and fixes the first casing 3 in the second casing 2.

Consequently, an outside of the first casing 3 is covered by the second casing 2, and external force is thereby prevented from being directly applied to the first casing 3 even in a case where external force is applied to the thermal protector 1. Further, the first casing 3 is fixed in the second casing 2 by the second filling material 6, and a situation can thereby be inhibited where the first casing 3 largely moves in the second casing 2 and those intensively collide with each other even in a case where external force is applied to the thermal protector 1. Thus, in the present configuration, deformation of the first casing 3 due to application of external force to the thermal protector 1 is inhibited, characteristics of the thermal protector can thereby be inhibited from changing due to deformation of the housing space 11, and as a result, a further improvement in reliability of the thermal protector 1 can be achieved.

The embodiment described in the foregoing is presented as an example and is not intended to limit the scope of the invention. This novel embodiment can be carried out in other various forms, and various kinds of omissions, substitutions, and changes can be performed without departing from the scope of the gist of the invention. The present embodiment and modifications thereof are included in the scope of gist of the invention and are included in the invention recited in the claims and the equivalent scope thereof.

1. A thermal protector comprising:
a base member which is configured with a resin having electric insulation and thermal plasticity;
a cover member which is configured with a resin having electric insulation, is mounted on the base member, and forms a housing space between the cover member and the base member;
a stationary contact and a movable contact which are provided in the housing space;
a fixing member which is provided with the stationary contact and is fixed to the base member;
a movable member which is provided with the movable contact, is configured to be deformable in the housing space, and exerts force in a direction, in which the movable contact contacts with the stationary contact, on the movable contact; and
a thermally actuated element which is housed in the housing space, performs a deformation operation by receiving heat, and exerts force in a direction, in which the movable contact moves apart from the stationary contact, on the movable member,
wherein the base member has a protrusion portion which is provided in the base member and protrudes from a surface of the base member,
wherein the cover member has a through hole portion which is formed in a position corresponding to the protrusion portion and is formed to pass through the cover member, and
wherein the base member and the cover member are fixed to each other by formation of a thermal caulking portion, for which thermal caulking is carried out, in a protruding portion, the protruding portion being the protrusion portion which is caused to pass through the through hole portion and protrudes to an outside of the cover member.

2. The thermal protector according to claim 1, further comprising:
a clip which is mounted on long-side portions of the base member and the cover member and interposes and retains the base member and the cover member from an outside of the base member and the cover member.

3. The thermal protector according to claim 1, wherein:
the movable member has two or more insertion hole portions formed to pass through the movable member in a thickness direction in a portion to be interposed between the base member and the cover member, and
the protrusion portion is inserted in the insertion hole portion.

4. The thermal protector according to claim 1, wherein:
the movable member is interposed between the base member and the cover member and is supported in a cantilever shape, and
a portion, which contacts with the movable member, in the cover member extends outside to a distal end side of the movable member relatively to the base member.

5. The thermal protector according to claim 1, further comprising:
an abutting member which is formed of metal and is provided in the cover member by insert molding and with which the movable member contacts in a case where the movable member deforms in the direction in which the movable contact moves apart from the stationary contact.

6. The thermal protector according to claim 1, wherein:
the thermally actuated element is arranged in the housing space without being fixed.

7. The thermal protector according to claim 1, further comprising:
a switch assembly which is assembled from the base member, the cover member, the stationary contact, the movable contact, the fixing member, the movable member, and the thermally actuated element;
a first casing which is configured to be capable of housing the switch assembly and has a first opening portion through which the switch assembly is inserted; and
a first filling material with which a portion in the first casing and around the switch assembly is filled through the first opening portion, wherein
the switch assembly has a step portion in a portion with which the first filling material contacts.

8. The thermal protector according to claim 7, further comprising:
a second casing which is configured to be capable of housing the first casing which houses the switch assembly and has a second opening portion through which the first casing is inserted; and
a second filling material with which an inside of the second casing is filled through the second opening portion and which seals the second opening portion and fixes the first casing in the second casing.
